(19) United States
(12) Patent Application Publication
(10) Pub. No.: US 2025/0232183 A1
(43) Pub. Date: Jul. 17, 2025

(54) METHOD AND APPARATUS FOR PERFORMING MULTI-AGENT META REINFORCEMENT LEARNING

(71) Applicant: ELECTRONICS AND TELECOMMUNICATIONS RESEARCH INSTITUTE, Daejeon (KR)

(72) Inventors: Jeong Min YANG, Daejeon (KR); Hyun Woo KIM, Daejeon (KR); Hwa Jeon SONG, Daejeon (KR); Young Hwan SHIN, Daejeon (KR); Byung Hyun YOO, Daejeon (KR); Eui Suk CHUNG, Daejeon (KR)

(21) Appl. No.: 18/978,172

(22) Filed: Dec. 12, 2024

(30) Foreign Application Priority Data
Jan. 11, 2024 (KR) 10-2024-0004939

(51) Int. Cl. G06N 3/092; G06N 3/0455

(52) U.S. Cl. CPC G06N 3/092; G06N 3/0455

(57) ABSTRACT

Disclosed is a method and apparatus for performing multi-agent meta reinforcement learning. The method for performing multi-agent meta reinforcement learning may include: selecting an event by extracting trajectory information for a task for pre-learning; defining a local group and a local state including one or more agents based on the selected event; learning a latent vector based on the defined local group and local state; and learning a strategy based on the latent vector and an action of the one or more agents.

### CROSS-REFERENCE TO RELATED APPLICATION(S)

This application claims the benefit of earlier filing date and right of priority to Korean Application No. 10-2024-0004939, filed on Jan. 11, 2024, the contents of which are all hereby incorporated by reference herein in their entirety.

### BACKGROUND

### 1. Technical Field

The present disclosure relates to a method and apparatus for performing multi-agent meta reinforcement learning.

### 2. Description of Related Art

Existing reinforcement learning has been developed in a way that a single agent learns actions or policies to maximize rewards for a given task. However, the field where reinforcement learning should actually be applied is mostly where multiple agents decide actions based on their own information and policies for cooperative or competitive goals.

Reinforcement learning in such an environment may be referred to as multi-agent reinforcement learning (MARL).

Meta learning is a research field that applies the human brain, which quickly adapts to new tasks that were not encountered during the learning phase, i.e., tasks that were not previously provided, to machine learning and solves problems. It corresponds to a ‘technique for learning how to learn.’

In this regard, the rhetorical definition of ‘learning how to learn’ in meta-learning may include any methodology that improves performance on datasets or tasks that were not used in the pre-learning phase.

Meta-learning may be based on conventional deep learning networks and additional (or higher, meta) algorithms/deep learning networks. Based on this, meta-learning may be classified into optimization-based methods, metric-based methods, model-based methods, etc. depending on the problem-solving approach.

### SUMMARY

The technical object of the present disclosure is to provide a method and apparatus for introducing a meta-learning element into a multi-agent reinforcement learning environment to improve adaptation and convergence speed for new tasks while maintaining generalization performance and expanding the range of solvable tasks.

The technical objects to be achieved by the present disclosure are not limited to the above-described technical objects, and other technical objects which are not described herein will be clearly understood by those skilled in the pertinent art from the following description.

A method for performing multi-agent meta reinforcement learning according to an aspect of the present disclosure may comprise: selecting an event by extracting trajectory information for a task for pre-learning; defining a local group and a local state including one or more agents based on the selected event; learning a latent vector based on the defined local group and local state; and learning a strategy based on the latent vector and an action of the one or more agents.

An apparatus of performing multi-agent meta reinforcement learning according to an additional aspect of the present disclosure may comprise at least one processor and at least one memory, and the processor may be configured to: select an event by extracting trajectory information for a task for pre-learning; define a local group and a local state including one or more agents based on the selected event; learn a latent vector based on the defined local group and local state; and learn a strategy based on the latent vector and an action of the one or more agents.

As one or more non-transitory computer readable medium storing one or more instructions according to an additional aspect of the present disclosure, the one or more instructions may be executed by one or more processors and control an apparatus for performing multi-agent meta reinforcement learning to: select an event by extracting trajectory information for a task for pre-learning; define a local group and a local state including one or more agents based on the selected event; learn a latent vector based on the defined local group and local state; and learn a strategy based on the latent vector and an action of the one or more agents.

In various aspects of the present disclosure, the method and operation may further comprise: inferring a latent vector based on local observation for a new task; and inferring a strategy and an action according to the strategy based on the inferred latent vector.

In this regards, inference of the latent vector for the new task may be based on a local state inferred by the local observation.

Additionally, in various aspects of the present disclosure, the task for the pre-learning may be randomly selected from a task distribution related to a plurality of tasks.

Additionally, in various aspects of the present disclosure, selection of the event may be performed by extracting a situation in which reward and an action involving multiple agents occur according to a change in observation by a specific agent.

Additionally, in various aspects of the present disclosure, the local group may be defined by grouping the one or more agents involved in the event, and a local observation may be extracted based on the local group, and the local state is extracted based on the local observation.

Additionally, in various aspects of the present disclosure, learning of the latent vector may be based on learning and deriving a local observation representation by a variational auto-encoder (VAE) that takes a local observation based on the local group as an input of an encoder and the local state as an output of a decoder.

Additionally, in various aspects of the present disclosure, learning of the strategy may be based on learning and deriving a strategy by a variational autoencoder (VAE) that takes the latent vector as an input of an encoder and the action as an output of a decoder.

Additionally, in various aspects of the present disclosure, if the local group includes a first agent and a second agent, the local group may be grouped based on one of a first case where the second agent belongs to an observation range of the first agent, a second case where the first agent belongs to an observation range of the second agent, or the third case where the second agent belongs to an observation range of the first agent and the first agent belongs to an observation range of the second agent.

According to the present disclosure, a method and apparatus for performing multi-agent meta reinforcement learning may be provided.

According to the present disclosure, by introducing a meta-learning element into a multi-agent reinforcement learning environment, there is a technical effect of improving adaptation and convergence speed for new tasks while maintaining generalization performance, and expanding the range of solvable tasks.

Effects achievable by the present disclosure are not limited to the above-described effects, and other effects which are not described herein may be clearly understood by those skilled in the pertinent art from the following description.

### BRIEF DESCRIPTION OF THE DRAWINGS

FIG. 1 illustrates the structure of a variant autoencoder that may be applied to an embodiment of the present disclosure.

FIG. 2 illustrates a learning process and an inference process in multi-agent meta reinforcement learning according to an embodiment of the present disclosure.

FIG. 3 illustrates an overall learning process for multi-agent meta reinforcement learning according to an embodiment of the present disclosure.

FIG. 4 illustrates a configuration diagram of a local group in multi-agent meta reinforcement learning according to an embodiment of the present disclosure.

FIG. 5 illustrates the operation of a local observation encoder and a local state decoder in multi-agent meta reinforcement learning according to an embodiment of the present disclosure.

FIG. 6 illustrates the operation of a strategy estimator and an action decoder in multi-agent meta reinforcement learning according to an embodiment of the present disclosure.

FIG. 7 illustrates an overall inference process for multi-agent meta reinforcement learning according to an embodiment of the present disclosure.

FIG. 8 illustrates an operational flowchart of a method for performing multi-agent meta reinforcement learning according to an embodiment of the present disclosure.

FIG. 9 is a block diagram illustrating a device according to an embodiment of the present disclosure.

### DETAILED DESCRIPTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

The proposed method and apparatus in the present disclosure relate to multi-agent meta reinforcement learning.

Specifically, the present disclosure proposes a method to introduce meta-learning elements into a multi-agent reinforcement learning environment to maintain generalization performance while increasing adaptation and convergence speed for new tasks, i.e., tasks not given in existing learning, and expanding the range of solvable tasks.

Hereinafter, i) multi-agent reinforcement learning (MARL), ii) StarCraft Multi-Agent Challenge (SMAC), iii) meta-learning, iv) meta reinforcement learning, and v) variational auto-encoder (VAE), which may be related to the proposed method and device in the present disclosure, are specifically described.

First, multi-agent reinforcement learning (MARL) will be described.

Existing reinforcement learning has been developed in a way that a single agent learns actions or policies to maximize rewards for a given task. However, the field in which reinforcement learning should actually be applied is mostly a case where multiple agents decide actions based on their own information and policies for cooperative or competitive goals.

Reinforcement learning in such an environment may be referred to as multi-agent reinforcement learning (MARL).

If MARL is approached in a fully centralized manner like the existing single-agent reinforcement learning method, convergence of learning is realistically impossible because the number of actions of all agents, i.e. the joint action space, increases exponentially as the number of agents increases. On the other hand, if MARL is approached in a fully decentralized manner, each agent only considers its own reward, and learning of cooperative or competitive behaviors between agents is impossible.

For this reason, a method of performing centralized training and decentralized execution (CTDE) that takes only the advantages of the two approaches described above and utilizes the observation information of all agents during the learning process, but determines actions based only on the observation information of each agent during the inference process may be considered.

For example, in relation to MARL, an approach that quantifies the contribution of a common reward to an agent may be considered. This approach can correspond to a credit assignment problem, and if this quantification is performed properly, each agent may explore actions with high common action-value functions using only its own utility function. To construct this relationship, a single-layer artificial neural network, a mixing network, is introduced.

Next, StarCraft Multi-Agent Challenge (SMAC) will be described.

MARL verification environments aim to obtain the highest reward through cooperative or competitive behavior between agents. For example, the most widely used environment recently is SMAC, which is a kind of mini-game environment that uses only some units from the popular game StarCraft 2 by Blizzard. Basically, in this environment, friendly and enemy units are given, and the goal is to defeat the enemy, which only performs rule-based actions.

For example, the first version of SMAC (e.g., SMACv1) was developed in the direction of learning each algorithm for this fixed environment (e.g., scenario) in which the types, numbers, and starting positions of friendly and enemy units were determined in advance before the game started. Therefore, all recent SMAC scenarios have been solved with a high win rate. Accordingly, a subsequent version (e.g., SMACv2) was announced, which is characterized by enhanced randomness of the environment compared to the existing SMAC. The types of friendly and enemy units may be determined probabilistically, and the initial placement of units is also randomly determined for each trial. The field of view and range of the units are also limited, so each agent shall decide on an action in a situation where it may observe only a part of the environment. For this reason, both QMIX and MAPPO (multi-agent proximal policy optimization), which showed strength in all existing SMAC scenarios, still performed well in some simple environments, but showed a sharp decline in win rate as the scenario became more complex.

Next, meta-learning will be described.

Meta-learning is a research field that applies the human brain, which quickly adapts to new tasks that were not encountered during the learning phase, i.e., tasks that were not previously provided, to solve problems, to machine learning. It corresponds to a ‘technique for learning how to learn.’

Existing deep learning networks have developed rapidly across all fields of supervised learning, unsupervised learning, and reinforcement learning, but have consistently shown poor performance in any application field for data not used for learning.

In particular, in reinforcement learning, networks learned to solve a specific task are generally unable to solve the problem and shall be retrained from the beginning even if only a part of the task is changed. For example, a reinforcement learning deep learning network that has learned how to escape a maze with fixed entrance and exit locations may not be able to solve the problem or may have its performance drastically reduced if the location of the entrance or exit is slightly changed.

Before the term meta-learning was coined, techniques to overcome the shortcomings of the aforementioned deep learning networks (i.e., low performance on data or tasks not encountered during learning) were studied in each application field.

For example, few-shot and zero-shot learning have been studied in the field of image classification. Here, few-shot learning is a field that improves image classification performance by using only an extremely limited number of data sets during the learning stage, and zero-shot learning is a field that classifies images that have not been encountered during the learning stage. Both are research fields that improve data efficiency and convergence speed. In addition, transfer learning is a research field that started from a similar problem awareness, and a methodology is considered to reduce the convergence time of the learning process by adding only a fine-tuning process when applying a network that has completed learning for one task to another task.

In this regard, the rhetorical definition of ‘learning how to learn’ in meta-learning may include any methodology that improves performance on datasets or tasks that were not used in the pre-learning phase.

Meta-learning may be based on conventional deep learning networks and additional (or higher, meta) algorithms/deep learning networks. Based on this, meta-learning may be classified into optimization-based methods, metric-based methods, model-based methods, etc. depending on the problem-solving approach.

As an optimization-based method, an iterative method may be considered to find a starting point that may converge the network with the highest generalization performance when a new task is encountered, that is, with the fewest training steps.

For example, when composed of a nested loop, a general deep learning process may be performed in the inner loop to calculate the gradient of the loss function of each task and calculate the degree of update of the weight for each task. Additionally, in the outer loop, the gradient of the sum of the gradients for each task is calculated, and based on this, the starting point of the network to be used in the next iteration can be derived.

While optimization-based meta-learning aims to reduce the learning (e.g. convergence) period, metric-based methods aim to learn metrics that may represent data that have not been encountered during the learning phase with appropriate location and distance. The aforementioned few-shot/zero-shot learning may also be solved by metric-based meta-learning, and may also be related to representation learning.

The model-based method is a method of quickly learning an existing network using an external network or memory, and may operate by storing information, data, and hyper-parameters of previously learned tasks.

Next, meta reinforcement learning will be described.

Meta-learning may also be applied to reinforcement learning, thereby solving the drawback of conventional reinforcement learning, which is the degradation of performance on tasks that were not encountered during learning (i.e., pre-learning).

All three methods mentioned above, that is, optimization-based method, metric-based method, and model-based method, may be effective in meta-reinforcement learning, and due to the characteristics of reinforcement learning, model-based method and metric-based method may be used in combination.

One such method, context-based meta reinforcement learning, aims to increase the convergence speed on a new task by using the relationship between the previous task and the new task.

A model-based method may be used in terms of storing previous tasks (or trajectories), and a metric-based approach may be used in terms of utilizing correlations between tasks. In order to improve the generalization performance of meta-reinforcement learning, a task augmentation method using a generative model or interpolation between multiple tasks may also be used.

For example, as meta-reinforcement learning, skill-based meta-policy learning (SiMPL) and Offline MARL algorithm to Discover coordination Skilles (ODIS) may be considered. Here, SiMRL assumes a single agent situation, defines the actions mainly used by the agent during the learning process as skills, and may convert tasks into latent vectors using a variational autoencoder (VAE). Through this, when performing a new task, actions may be determined based on the skills used when performing similar tasks in the past. Additionally, ODIS assumes a multi-agent situation, defines the actions mainly used by the agents during the learning process as skills, and thus the zero-shot problem can be solved.

Finally, variational auto-encoder (VAE) will be described.

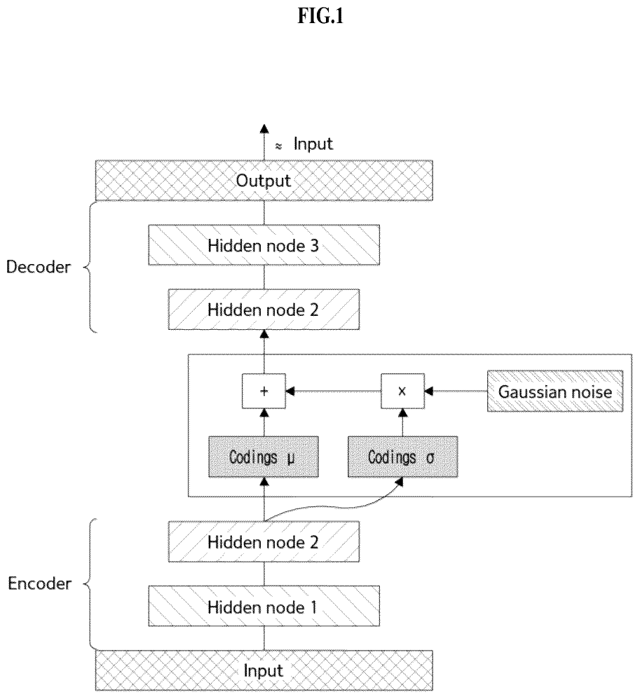

FIG. 1 illustrates the structure of a variant autoencoder that may be applied to an embodiment of the present disclosure.

Referring to FIG. 1, VAE is an artificial neural network that combines an encoder and a decoder, and may be utilized for information compression and generative artificial neural networks by diversifying learning conditions according to the purpose.

In this regard, the encoding process aims to perform information compression and latent vector generation through feature extraction, and the decoding process may aim to restore data and generate new data within a similar distribution.

At this time, the latent vector may be learned using KL divergence, etc. with a probability distribution of restricted dimension, as a loss function depending on the purpose. If the purpose is feature extraction and information compression, learning is mainly performed using the same data for input and output, and only the encoder may be mainly used after learning. If it is used for a generative model, a decoder is used, and new data (e.g., images, texts, etc.) in the manner desired by the user may be generated depending on the data processing applied to the latent vector.

Meta reinforcement learning as described above may utilize information on previously learned tasks in the form of latent vectors. At this time, the process of extracting task features is essential, and VAE may be a tool for extracting task features.

As mentioned above, meta-learning and meta-reinforcement learning aim to quickly adapt to new tasks (i.e., unlearned tasks) that were not encountered during the learning phase (e.g., pre-learning phase). Therefore, meta-learning and meta-reinforcement learning aim to find a learning point that is performance-neutral across tasks while avoiding overfitting to a specific task as much as possible.

In other words, it is necessary to solve two problems simultaneously: maximizing generalization performance and quickly adapting to new tasks. Considering this, meta-learning elements have been applied to reinforcement learning and developed/researched as context-based meta-reinforcement learning.

Additionally, multi-agent reinforcement learning requires a lot of computation for learning convergence as the joint action space becomes exponentially larger compared to conventional reinforcement learning, and at the same time, the convergence speed for learning new tasks is significantly slow.

As described above, a method may be needed to add elements of context-based meta-reinforcement learning to multi-agent reinforcement learning to increase the speed of adaptation to new tasks while expanding the range of tasks that multi-agent meta-reinforcement learning may solve.

Accordingly, the present disclosure specifically proposes a method for performing learning by providing elements of meta-reinforcement learning to multi-agent reinforcement learning.

In connection with the method described in the present disclosure below, one or more of the following situations may be assumed.

1) Since the task in a multi-agent environment is approached in a centralized training and decentralized execution (CTDE) manner, a situation, which is information of all agents, is used, but when making inference, the agents may only use the observation information collected by each agent.

2) A situation where a set of tasks in a multi-agent environment is given/provided

3) A situation where pre-learning is performed using tasks randomly selected from a task set, and trajectory data (e.g., state, action, reward, next state) is collected for each task during the pre-learning process.

4) A situation where a new task is given/provided randomly selected from among tasks that were not used in pre-learning in the task set.

Additionally, the method described in the present disclosure below may be proposed to solve one or more of the following problems.

### 1) Difficulty in Measuring Similarity Between Tasks

When a task similar to a pre-learned task is given, the learned knowledge should be utilized to the maximum extent possible, but due to the complexity of the MARL environment, each task is often considered an independent problem.

### 2) Task Scalability Problem

Scalability may be low when tasks that may already be solved well are simply combined. For example, in a SMAC environment, if the Marine 3 vs. Marine 2 problem and the Marine 5 vs. Marine 4 problem are perfectly learned, the Marine 8 vs. Marine 6 problem, which is simply a combination of the two scenarios, shall be solved through a divide-and-conquer method that makes maximum use of the previously learned strategy, but the method is not used in the learning process.

### 3) Efficiency and Sensitivity Issues of Datasets

When a new task is given, performance generally increases as the number of pre-learned tasks increases, but since it is not a proportional relationship, the efficiency of the data set decreases, and the selection of the pre-learning scenario itself is important and has high sensitivity.

In order to solve the problem in the above-mentioned situation, the present disclosure proposes a method of applying meta-learning/reinforcement learning elements to multi-agent reinforcement learning through specific examples.

The learning process and inference process in the proposed method in the present disclosure may be as follows.

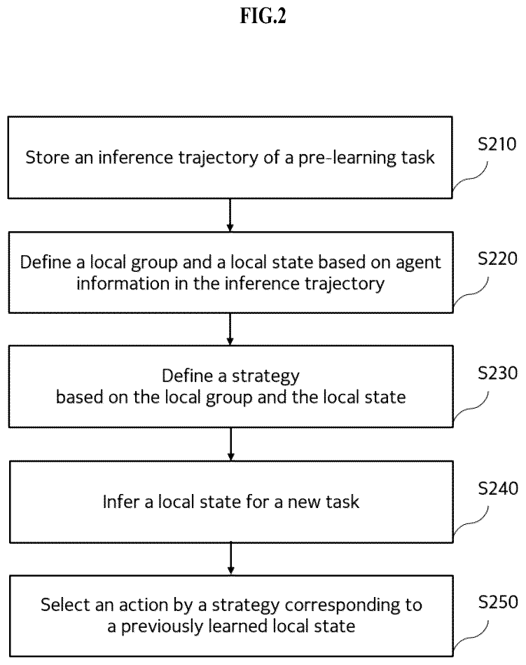

FIG. 2 illustrates a learning process and an inference process in multi-agent meta reinforcement learning according to an embodiment of the present disclosure.

First, information for the inference trajectory of a pre-learning task randomly selected from a task set may be stored (S210).

A local group and a local state may be defined based on the agent information in the stored inference trajectory (S220). Specifically, an event in which the observation content or reward is drastically changed may be selected from the agent information in the trajectory, and the associated agent may be defined as a local group, and the information at this time may be defined as a local state.

A strategy may be defined and learned based on the defined local group and local state (S230). Specifically, repeated actions, cooperative actions, and/or competitive actions between agents within a local group in a similar local state may be defined and learned as a strategy.

At this time, if a new task is given, the local state may be inferred (S240). Specifically, if a new task is given, the local state may be inferred from the agent's local observation information.

Afterwards, an action may be selected by a strategy corresponding to the previously learned local state (S250).

In the procedures described above in FIG. 2, steps S210 to S230 may correspond to a learning process, and steps S240 and S250 may correspond to an inference process.

Hereinafter, the learning process described in the aforementioned FIG. 2 will be described in detail through drawings and examples.

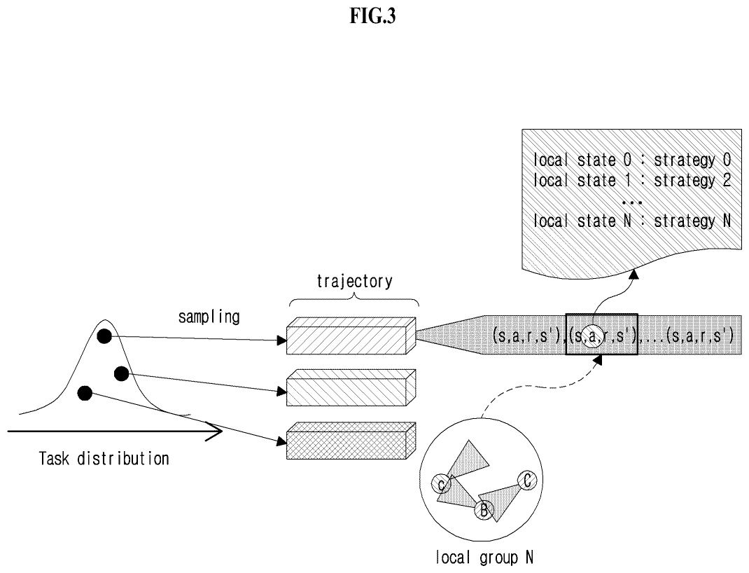

FIG. 3 illustrates an overall learning process for multi-agent meta reinforcement learning according to an embodiment of the present disclosure.

Referring to FIG. 3, first, k tasks for learning may be randomly selected (sampled) from the task distribution, i.e., T={T₁, T₂, T₃, . . . , T_{N}}.

Afterwards, the inference results for the selected task may be extracted as a trajectory.

For example, in the case of a task in which state transitions occur m times, the trajectory information of the task may be configured as in Equation 1.

$${τ}_{k} = {\{ s , a , r , {s}^{′} \}}_{m}^{k} = {\{ s , a , r , {s}^{′} \}}_{m} , {\{ {s}^{′} , {a}^{′} , {r}^{′} , {s}^{′′} \}}_{m} , … \qquad [ Equation 1 ]$$

In Equation 1, “s” may represent a state, “a” may represent an action, and a prime (′) may mean the next time step.

With respect to Equation 1, from a CTDE perspective, “s(state)” is assumed to contain information about all agents, but in reality, agents only have information for their own observations.

Therefore, the trajectory information of the task based on the i-th agent (i.e., agent i) may be configured as in Equation 2.

$${τ}_{k , i} = {\{ o , a , r , {o}^{′} \}}_{m}^{k , i} = {\{ o , a , r , {o}^{′} \}}_{m} , {\{ {o}^{′} , {a}^{′} , {r}^{′} , {o}^{′′} \}}_{m} , … \qquad [ Equation 2 ]$$

Additionally, the trajectory information of the selected entire task may be configured as in Equation 3.

$$τ = \{ {τ}_{1} , {τ}_{2} , {τ}_{3} , … , {τ}_{k} \} \qquad [ Equation 3 ]$$

In this regard, the extraction of trajectories may be performed via a pre-known/defined pre-trained model (e.g., offline reinforcement learning) or via the output of the proposed method in the present disclosure (e.g., online reinforcement learning). Additionally or alternatively, the extraction of trajectories may be performed by combining a pre-known/defined pre-trained model and the output of the proposed method in the present disclosure.

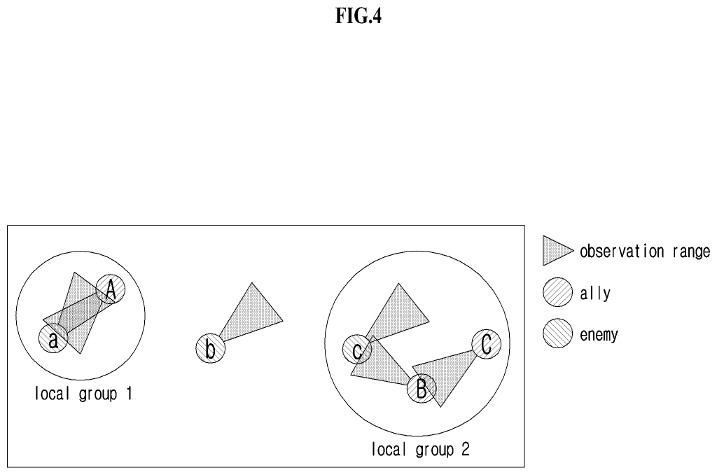

FIG. 4 illustrates a configuration diagram of a local group in multi-agent meta reinforcement learning according to an embodiment of the present disclosure.

Referring to FIG. 4, a plurality of agents may be composed of agents having ally characteristics and agents having enemy characteristics. In this case, each agent may have an observation range.

For example, if a change in the final reward occurs due to an action within the aforementioned trajectory information (e.g., τ_{k,i} in Equation 2), that case may be selected as an event.

At this time, the set of agents involved in the incident may be defined as a local group (LG), and the observation information of each agent within the local group may be defined as a local observation (LO), and the state at this time may be defined as a local state (LS).

Specifically, the local group, local observation, and local state for event e may be expressed as in Equation 4.

$$for event e , LG = \{ {a}_{1} , {a}_{2} , … , {a}_{l} \} , LO = {\{ {a}_{1} , {a}_{2} , … , {a}_{l} \}}_{obs} , LS = {\{ {a}_{1} , {a}_{2} , … , {a}_{l} \}}_{state} \qquad [ Equation 4 ]$$

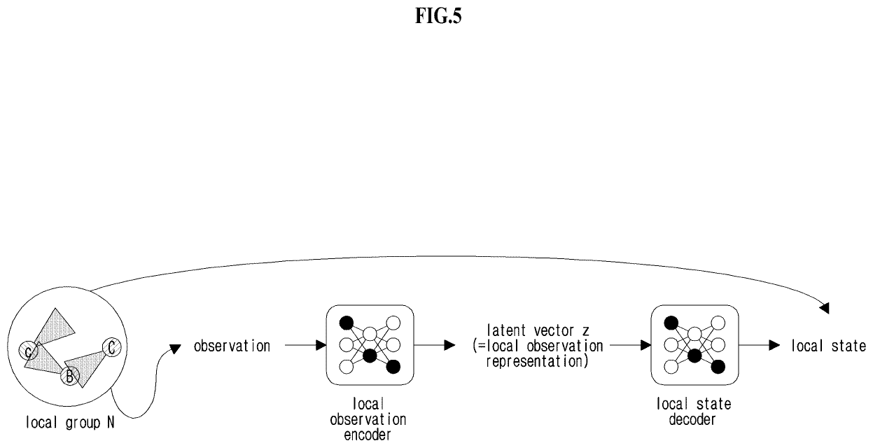

FIG. 5 illustrates the operation of a local observation encoder and a local state decoder in multi-agent meta reinforcement learning according to an embodiment of the present disclosure.

Referring to FIG. 5, a local state may be extracted/estimated based on a local group N.

Specifically, a local observation encoder (LOE) and local state decoder (LSD) network, which is a VAE structure that may estimate local states only through observations of local group N via local observations (LOs) and local states (LSs), may be learned.

A local observation encoder (LOE) may derive a latent vector z based on observations for a local group N. Then, a local state decoder may estimate a local state (LS) based on the derived latent vector z.

Here, the latent vector z, which is the output of the local observation encoder (LOE), is a latent vector containing information of the local observation (LO) and may be used as a local observation representation z.

The local state estimation in FIG. 5 may be expressed as in Equation 5.

$$z = LOE ( LO ) , LS = LSD ( z ) \qquad [ Equation 5 ]$$

Referring to Equation 5, a local observation (LO) may be input to a local observation encoder (LOE) to output a latent vector z, and a latent vector z may be input to a local state decoder (LSD) to output a local state (LS).

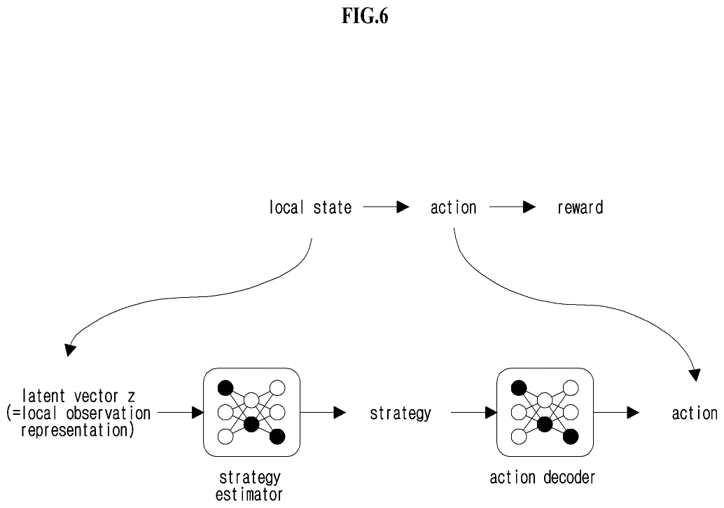

FIG. 6 illustrates the operation of a strategy estimator and an action decoder in multi-agent meta reinforcement learning according to an embodiment of the present disclosure.

Referring to FIG. 6, an action may be derived based on a local state (LS), and a reward may be given based on the action.

In this regard, the strategy estimator (SE) may be set to receive the aforementioned latent vector z as input and output a strategy, and the action decoder (AD) may be set to receive the strategy output by the strategy estimator as input and output an action.

Here, the latent vector z may be based on the local state (LS) as in FIG. 5.

For example, using a known local state (LS) and a latent vector z, a strategy, which is the most frequently used action by agents in a local group (LG) in a specific local state, may be learned through a strategy estimator and an action decoder corresponding to a VAE structure.

The strategy and action estimation in FIG. 6 may be expressed as in Equation 6.

$$strategy = SE ( z ) , action = AD ( strategy ) \qquad [ Equation 6 ]$$

Referring to Equation 6, a latent vector z may be input into a strategy estimator (SE) to output a strategy, and a strategy may be input into an action decoder (AD) to output an action.

Next, the inference process described in the aforementioned FIG. 2 will be described in detail through drawings and examples.

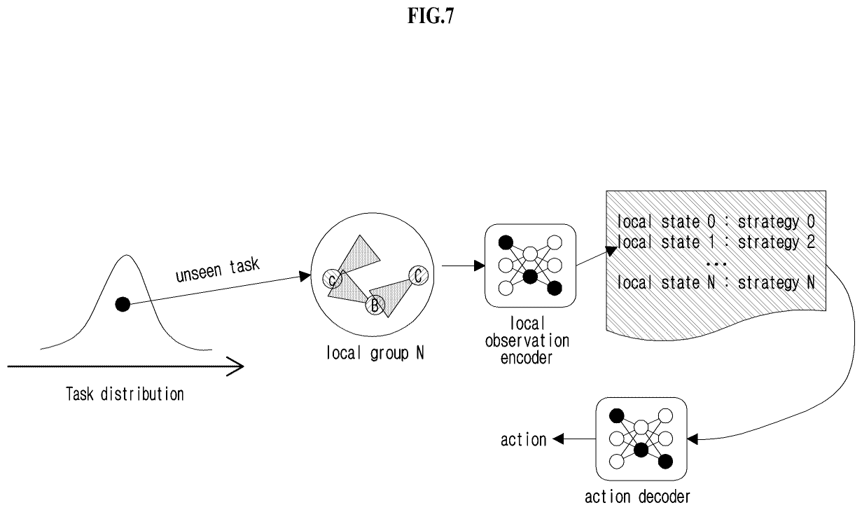

FIG. 7 illustrates an overall inference process for multi-agent meta reinforcement learning according to an embodiment of the present disclosure.

Referring to FIG. 7, a task that has not been used in pre-learning (i.e., an unseen task) may be selected (sampled) from the task distribution. Here, the task may be expressed as Tᵤₙₛₑₑₙ.

Additionally, an observation group (OG), which is a local group (LG) based on observation, may be formed. At this time, agents that recognize each other's information through observation may be defined as an observation group.

Afterwards, a latent vector z of the corresponding observation group (i.e., local observation representation z) may be derived using a local observation encoder (LOE) (e.g., the local observation encoder in FIG. 5) learned based on the VAE structure as described above. Additionally, a strategy and an action corresponding to the strategy may be derived using a strategy estimator and/or an action decoder (e.g., the strategy estimator and/or the action decoder in FIG. 6) learned based on the VAE structure as described above.

The inference process in FIG. 7 may be expressed as Equation 7.

$$z = LOE ( OG ) , strategy = SE ( z ) , action = AD ( strategy ) \qquad [ Equation 7 ]$$

Referring to Equation 7, an observation group (OG) may be input to a local observation encoder (LOE) to output a latent vector z, the latent vector z output to a strategy estimator (SE) to output a strategy, and the strategy output to an action decoder (AD) to output an action.

Additionally or alternatively, in the case of a deep learning network requiring learning in the proposed method in the present disclosure, two pairs of VAE networks may be included/configured.

For example, a first VAE network consisting of a local observation encoder (LOE) and a local state decoder (LSD) such as the aforementioned FIG. 5 may be constructed and learned.

Specifically, the observation information is input to a local observation encoder (LOE), and the local observation encoder (LOE) may output a local observation representation z, i.e., a latent vector z, based on the local observation representation z. Thereafter, the local observation representation z is input to a local state decoder (LSD), and the local state decoder (LSD) may derive/output/estimate a local state. At this time, learning may be performed so that the latent vector z follows a Gaussian distribution.

For example, a second VAE network consisting of a strategy estimator (SE) and an action decoder (AD) such as the aforementioned FIG. 6 may be constructed and learned.

Specifically, the local observation representation z, i.e., the latent vector z, is input to the strategy estimator (SE), and the strategy estimator (SE) may output strategy information based on it. Thereafter, the strategy information is input to the action decoder (AD), and the action decoder (AD) may output an action corresponding to the input strategy. At this time, depending on the situation, learning may be performed so that the strategy follows a Gaussian distribution, a normal distribution, etc.

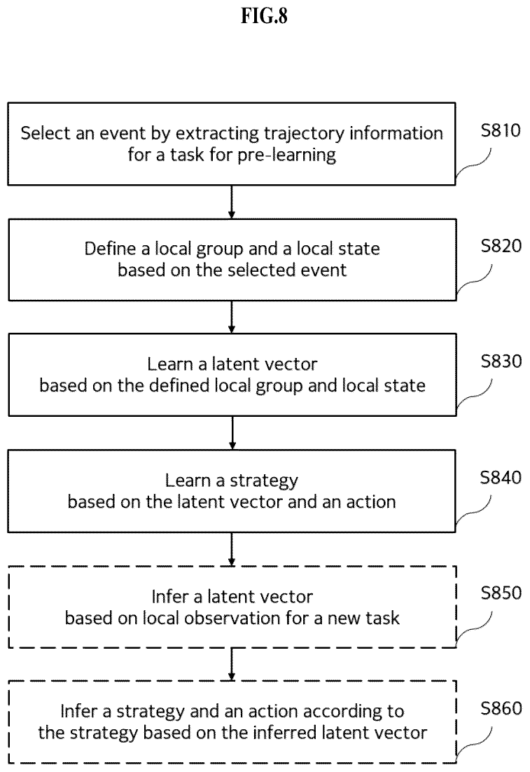

FIG. 8 illustrates an operational flowchart of a method for performing multi-agent meta reinforcement learning according to an embodiment of the present disclosure.

Referring to FIG. 8, an event may be selected by extracting trajectory information for a task for pre-learning (S810).

In this regard, the task for the above pre-learning may be randomly selected from a task distribution related to a plurality of tasks.

Additionally, the selection of the event may be performed by extracting a situation in which an action and reward involving multiple agents occur according to a change in observation by a specific agent.

Based on the event selected in step S810, a local group and a local state including one or more agents may be defined (S820).

In this regard, the local group may be defined by grouping one or more agents involved in the event, a local observation may be extracted based on the local group, and the local state may be extracted based on the local observation.

Additionally or alternatively, when the local group includes a first agent and a second agent, the local group may be grouped based on one of a first case in which the second agent falls within the observation range of the first agent, a second case in which the first agent falls within the observation range of the second agent, or a third case in which the second agent falls within the observation range of the first agent and the first agent falls within the observation range of the second agent.

Based on the local group and local state defined in step S820, a latent vector may be learned (S830).

In this regard, the learning of the latent vector may be based on the learning and derivation of a local observation representation by a variational auto-encoder (VAE) that takes local observations based on the local group as input to the encoder and the local state as output to the decoder.

A strategy may be learned based on the latent vector in step S830 and the actions of one or more agents (S840).

In this regard, learning of the strategy may be based on learning and derivation of the strategy by a variational autoencoder (VAE) that takes the latent vector as an input of the encoder and the action as an output of the decoder.

Additionally, after the pre-learning process as described above is performed, the inference process may be performed.

Specifically, a latent vector is inferred based on local observation for a new task (S850), and a strategy and an action according to the strategy may be inferred based on the inferred latent vector (S860).

In this regard, the inference of the latent vector for the new task may be based on the local state inferred by the local observation.

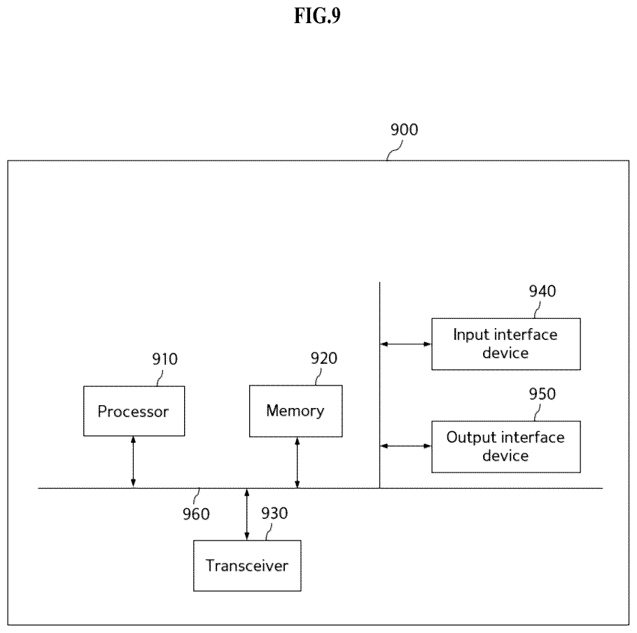

FIG. 9 is a block diagram illustrating an apparatus according to an embodiment of the present disclosure.

Referring to FIG. 9, the device (900) may represent a device implementing a method for performing multi-agent meta reinforcement learning proposed in the present disclosure.

The device 900 may include at least one of a processor 910, a memory 920, a transceiver 930, an input interface device 940, and an output interface device 950. Each of the components may be connected by a common bus 960 to communicate with each other. In addition, each of the components may be connected through a separate interface or a separate bus centering on the processor 910 instead of the common bus 960.

The processor 910 may be implemented in various types such as an application processor (AP), a central processing unit (CPU), a graphic processing unit (GPU), etc., and may be any semiconductor device that executes a command stored in the memory 920. The processor 910 may execute a program command stored in the memory 920. The processor (910) may be configured to implement a method and device for performing multi-agent meta reinforcement learning based on FIGS. 1 to 8 described above.

And/or, the processor 910 may store a program command for implementing at least one function for the corresponding modules in the memory 920 and may control the operation described based on FIGS. 1 to 8 to be performed.

The memory 920 may include various types of volatile or non-volatile storage media. For example, the memory 920 may include read-only memory (ROM) and random access memory (RAM). In an embodiment of the present disclosure, the memory 920 may be located inside or outside the processor 910, and the memory 920 may be connected to the processor 910 through various known means.

The transceiver 930 may perform a function of transmitting and receiving data processed/to be processed by the processor 910 with an external device and/or an external system.

The input interface device 940 is configured to provide data to the processor 910.

The output interface device 950 is configured to output data from the processor 910.

According to the present disclosure, a method and apparatus for performing multi-agent meta reinforcement learning may be provided.

According to the present disclosure, by introducing a meta-learning element into a multi-agent reinforcement learning environment, there is a technical effect of improving adaptation and convergence speed for new tasks while maintaining generalization performance, and expanding the range of solvable tasks.

Specifically, meta-learning is a field that shall simultaneously solve the problem of having conflicting goals of maximizing generalization performance while quickly adapting to new tasks. The proposed method in the present disclosure applies a method of learning after decomposing it into local groups in the pre-learning stage for tasks to resolve the inefficiency of the dataset that inevitably occurs in this process. Through this, it is possible to learn a method that utilizes strategies for partially similar situations among the pre-learned knowledge for tasks that were not learned in the pre-learning stage.

The components described in the example embodiments may be implemented by hardware components including, for example, at least one digital signal processor (DSP), a processor, a controller, an application-specific integrated circuit (ASIC), a programmable logic element, such as an FPGA, GPU other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers.

A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors. Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment.

Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, it is intended that this disclosure embrace all other substitutions, modifications and variations belong within the scope of the following claims.

What is claimed is:

1. A method for performing multi-agent meta reinforcement learning, the method comprising:
selecting an event by extracting trajectory information for a task for pre-learning;
defining a local group and a local state including one or more agents based on the selected event;
learning a latent vector based on the defined local group and local state; and
learning a strategy based on the latent vector and an action of the one or more agents.

2. The method of claim 1, further comprising:
inferring a latent vector based on local observation for a new task; and
inferring a strategy and an action according to the strategy based on the inferred latent vector.

3. The method of claim 1,
wherein the task for the pre-learning is randomly selected from a task distribution related to a plurality of tasks.

4. The method of claim 1,
wherein selection of the event is performed by extracting a situation in which reward and an action involving multiple agents occur according to a change in observation by a specific agent.

5. The method of claim 1,
wherein the local group is defined by grouping the one or more agents involved in the event, and
wherein a local observation is extracted based on the local group, and the local state is extracted based on the local observation.

6. The method of claim 1,
wherein learning of the latent vector is based on learning and deriving a local observation representation by a variational auto-encoder (VAE) that takes a local observation based on the local group as an input of an encoder and the local state as an output of a decoder.

7. The method of claim 1,
wherein learning of the strategy is based on learning and deriving a strategy by a variational autoencoder (VAE) that takes the latent vector as an input of an encoder and the action as an output of a decoder.

8. The method of claim 2,
wherein inference of the latent vector for the new task is based on a local state inferred by the local observation.

9. The method of claim 1,
wherein, if the local group includes a first agent and a second agent,
the local group is grouped based on one of a first case where the second agent belongs to an observation range of the first agent, a second case where the first agent belongs to an observation range of the second agent, or the third case where the second agent belongs to an observation range of the first agent and the first agent belongs to an observation range of the second agent.

10. An apparatus of performing multi-agent meta reinforcement learning, the apparatus comprising:
at least one processor and at least one memory,
wherein the processor is configured to:
select an event by extracting trajectory information for a task for pre-learning;
define a local group and a local state including one or more agents based on the selected event;
learn a latent vector based on the defined local group and local state; and
learn a strategy based on the latent vector and an action of the one or more agents.

11. The apparatus of claim 10, the processor is configured to:
infer a latent vector based on local observation for a new task; and
infer a strategy and an action according to the strategy based on the inferred latent vector.

12. The apparatus of claim 10,
wherein the task for the pre-learning is randomly selected from a task distribution related to a plurality of tasks.

13. The apparatus of claim 10,
wherein selection of the event is performed by extracting a situation in which reward and an action involving multiple agents occur according to a change in observation by a specific agent.

14. The apparatus of claim 10,
wherein the local group is defined by grouping the one or more agents involved in the event, and
wherein a local observation is extracted based on the local group, and the local state is extracted based on the local observation.

15. The apparatus of claim 10,
wherein learning of the latent vector is based on learning and deriving a local observation representation by a variational auto-encoder (VAE) that takes a local observation based on the local group as an input of an encoder and the local state as an output of a decoder.

16. The apparatus of claim 10,
wherein learning of the strategy is based on learning and deriving a strategy by a variational autoencoder (VAE) that takes the latent vector as an input of an encoder and the action as an output of a decoder.

17. The apparatus of claim 16,
wherein inference of the latent vector for the new task is based on a local state inferred by the local observation.

18. The apparatus of claim 10,
wherein, if the local group includes a first agent and a second agent,
the local group is grouped based on one of a first case where the second agent belongs to an observation range of the first agent, a second case where the first agent belongs to an observation range of the second agent, or the third case where the second agent belongs to an observation range of the first agent and the first agent belongs to an observation range of the second agent.

19. One or more non-transitory computer readable medium storing one or more instructions,
wherein the one or more instructions are executed by one or more processors and control an apparatus for performing multi-agent meta reinforcement learning to:
select an event by extracting trajectory information for a task for pre-learning;
define a local group and a local state including one or more agents based on the selected event;
learn a latent vector based on the defined local group and local state; and
learn a strategy based on the latent vector and an action of the one or more agents.

20. The one or more non-transitory computer readable medium of claim 19,
wherein the one or more instructions control an apparatus to:
infer a latent vector based on local observation for a new task; and
infer a strategy and an action according to the strategy based on the inferred latent vector.
